(19) United States
(12) Patent Application Publication
(10) Pub. No.: US 2026/0097688 A1
(43) Pub. Date: Apr. 9, 2026

(54) METHOD FOR HEATING COMPONENTS OF A VEHICLE

(71) Applicant: ZF Friedrichshafen AG, Friedrichshafen (DE)

(72) Inventors: Thorsten LEIM, Friedrichshafen (DE); Stefan BLATTNER, Ravensburg (DE); Stefan BEMETZ, Wangen im Allgäu (DE); Dennis WOHLFAHRT, Kressbronn am Bodensee (DE); Christian MITTELBERGER, Ravensburg (DE); Jochen BREUER, Tettnang (DE); Mario STEINBORN, Friedrichshafen (DE); Fabian LEY, Mannheim (DE); Hannes WERNER, Friedrichshafen (DE); Stefan SPÜHLER, Friedrichshafen (DE); Benjamin BERGER, Markdorf (DE)

(73) Assignee: ZF Friedrichshafen AG, Friedrichshafen (DE)

(21) Appl. No.: 19/350,672

(22) Filed: Oct. 6, 2025

(30) Foreign Application Priority Data
Oct. 8, 2024 (DE) 10 2024 209 784.5

(51) Int. Cl. B60L 58/25; B60L 15/20; B60L 50/51

(52) U.S. Cl. CPC B60L 58/25; B60L 15/20; B60L 50/51; B60L 2210/44

(57) ABSTRACT

A method is provided for heating components of a vehicle having a first electric drive unit, a second electric drive unit, and an inverter system for supplying the electric drive units with alternating current. The first electric drive unit produces a first torque and the second electric drive unit produces a second torque, where a sum of the first and second torques is a driving torque. For producing a desired driving torque the first electric drive unit is operated as a generator and the second electric drive unit is operated as a motor so that a total current flow is produced in the inverter system that is greater than a total current flow that would be produced in the inverter system when both electric drive units are operated as motors to produce the desired driving torque.

### RELATED APPLICATIONS

This application claims the benefit of and right of priority under 35 U.S.C. § 119 to German Patent Application no. 10 2024 209 784.5, filed on 8 Oct. 2024, the contents of which are incorporated herein by reference in its entirety.

### TECHNICAL FIELD

The invention relates to a method for heating components of a vehicle, and to a system, a vehicle, a computer program, and a computer-readable medium for carrying out the method.

### BACKGROUND

At low temperatures the viscosity of oil is higher, so that a sufficient supply of oil to vehicle components is sometimes not guaranteed in such situations. Especially in electric vehicles, temperatures which are too low can also reduce the efficiency of components such as inverters and batteries.

Furthermore, at cold temperatures batteries can only take up energy to a limited extent and this, for example, can have negative effects on recuperation and also on shifting processes (in particular on synchronization in vehicles with switchable electric drives). Accordingly, it is important in electric vehicles for various components and oil to reach their operating temperatures quickly.

The systems known so far for increasing quickly the temperature of components and oil in electric vehicles have various disadvantages. For example, they do not work satisfactorily in relation to the rate of temperature increase or in relation to energy efficiency.

### SUMMARY

The purpose of the present invention is to overcome or at least reduce the disadvantages of the prior art.

This objective is achieved by a method for heating components of a vehicle, wherein the vehicle comprises a first electric drive unit and a second electric drive unit, wherein the first electric drive unit produces a first torque and the second drive unit produces a second torque, wherein the sum of the first and second torques is a driving torque, wherein the vehicle comprises an inverter system for supplying the electric drive units with alternating current, wherein in the context of the method for producing a desired driving torque the first electric drive unit is operated as a generator and the second electric drive unit is operated as a motor, in such manner that a total current flow in the inverter system is produced which is higher than a total current flow would be in the inverter system if both electric drive units were operated as motors in order to produce the desired driving torque.

In this context, the electric drive units can each be, for example, an electric motor, in particular an alternating-current motor and especially a three-phase motor, or each of the electric drive units can comprise such a motor, for example.

The objective is achieved by such a method since owing to the larger current flow produced, particularly in the inverter system, by not operating both electric drive units as motors but by operating one of the two electric drive units as a generator (in other words braked), the components of the drive system of the vehicle and especially the inverters in the inverter system heat up more rapidly than they would in the case when both electric drive units are operated exclusively as motors in order to produce the desired driving torque. These larger current flows result in higher heat losses in the components involved, for example in the inverters, in the electric drive units and also in the batteries, cables, and the like involved, which then also has the result that the oil surrounding the components heats up more quickly than when the total current flow in the inverter system is smaller.

In advantageous embodiments, the inverter system comprises a first inverter for supplying the first electric drive unit with alternating current, and a second inverter for supplying the second electric drive unit with alternating current, wherein the first inverter produces a direct-current output and makes this direct-current output available to the second inverter as an inverter direct current input. Such a design has the advantage that the alternating current produced by operating the first electric drive unit as a generator and fed into the first inverter additionally heats that inverter. In addition, a design of this type has the advantage that since the direct current which is produced by the first inverter from the alternating current delivered by the first electric drive unit is in turn fed into the second inverter, particularly good energy efficiency of the system as a whole is achieved, for example compared with alternative designs in which the first inverter would feed the direct current it produces back into a battery, which would give rise to battery charging losses. Thus, by virtue of this special type of design, a synergy effect is produced with the result that thanks to the larger total current flow through the inverter system, on the one hand components can be heated more rapidly and on the other hand, thanks to the direct back-feeding of direct current produced from the first inverter operating as a generator into the second inverter, particularly good energy efficiency can be achieved.

In advantageous embodiments, a battery direct current input is provided to the second inverter in addition to the inverter direct current input. This battery direct current input is typically supplied by a battery of the vehicle or by several batteries of the vehicle.

In advantageous embodiments, the vehicle has two batteries, and the inverter system comprises two inverters and each of the two inverters is electrically connected exclusively to one of the two batteries so that each inverter has a battery of its own, whereby each of the two inverters is electrically connected exclusively to one of the two electric drive units so that each inverter has its own electric drive unit, whereby the inverter whose electric drive unit is working as a generator feeds a direct current into its battery and whereby a direct current is fed from its battery into the inverter whose electric drive unit is working as a motor. The expression “electrically connected exclusively” is to be understood to mean that direct currents can flow between the inverter and the battery concerned, or between the inverter and the electric drive unit concerned. Thus, indirect connections, for example via the body of the vehicle, do not come under the expression “electrically connected exclusively.”

In advantageous embodiments, during the course of the method, depending on the charging condition at the time and/or the temperature of the two batteries, it is determined, preferably continuously, into which of the two batteries current is fed and from which of the two batteries current is drawn. In other words, typically, during the course of the method it is decided continuously and again and again which of the two electric drive units should in fact be the first drive unit (i.e., the one operating as a generator) and which of the two electric drive units should be the second drive unit (i.e., the one operating as a motor). Depending on the charge condition of the batteries at the time, for example the drive unit connected via its inverter to the least-charged battery can operate as a generator until the charge conditions of the batteries have become equal again. Thereafter, the other electric drive unit can operate as a generator, and so on. In that way the charge conditions of the two batteries can be kept at a similar level.

In advantageous embodiments, each electric drive unit comprises a plurality of electric motors, and the electric motors of each drive unit can be operated all as motors, all as generators, or some as motors and some as generators. Such a design of the method enables the method to be used particularly flexibly.

In advantageous embodiments, the inverter system comprises more than two inverters, wherein a direct current from at least one battery and/or a direct current from at least one other inverter is fed into at least one inverter, and wherein at least one inverter feeds a direct current into at least one battery and/or at least one other inverter. The above-described concepts in which the inverter system comprises more than two inverters, for example three, four, five, or more inverters, can also be used. In advantageous embodiments, the method comprises more than two batteries, and the above-described charging and discharging concepts for two batteries can also be applied in cases when there are more than two batteries.

The objective is also achieved by a system comprising means for at least partially carrying out a method in accordance with at least one of the aforesaid embodiments.

Typically, such a system comprises at least one control unit, which can set one electric drive unit into motor operation and at the same time set a further electric drive unit into generator operation in such manner that a desired driving torque is produced. In typical embodiments, such a system also comprises a charge-regulating component which is suitable for ensuring that during the course of the method the charging of all the batteries involved is kept essentially at a comparable level, for example such that the charging of the individual batteries does not differ by more than 20%, preferably by more than 15%, and better still by more than 10%.

In advantageous embodiments, the system is suitable for carrying out and/or coordinating and/or controlling a method for heating components of a vehicle in accordance with at least one of the aforesaid embodiments. For that purpose, the system typically comprises means for carrying out and/or coordinating and/or controlling a method according to at least one of the aforesaid embodiments.

Advantageously, in the system at least some of the aforesaid components are implemented by means of computer program codes. In advantageous embodiments the system, in particular at least some of the components, are at least part of a vehicle control system and/or a Cloud. In typical embodiments the system is or comprises a control unit, in particular a vehicle control unit.

In an embodiment of the invention, a vehicle can carry out a method according to at least one of the aforesaid embodiments and/or comprises a system according to one of the embodiments. For that purpose, the vehicle typically contains means for carrying out a method according to at least one of the embodiments.

In an embodiment of the invention, a computer program contains commands which, when the computer program is run on a computer, enable it to carry out one of the methods. The computer program can also be called a computer program product.

In an embodiment of the invention, a computer-readable medium contains computer program codes for carrying out one of the methods. The term “computer-readable medium” is understood to mean, in particular but not exclusively, hard disks and/or servers and/or memory sticks and/or flash memories and/or DVDs and/or Bluerays and/or CDs. In addition, the term “computer-readable medium” is understood to mean a data flow as is produced for example when a computer program and/or a computer program product is downloaded from the internet.

### BRIEF DESCRIPTION OF THE DRAWINGS

Below, the invention is explained briefly with reference to drawings, which show:

FIG. 1: A first schematic representation of a method according to the invention, in the form of a torque diagram,

FIG. 2: A schematic representation of a first embodiment of a method according to the invention, in the form of a block diagram,

FIG. 3: A schematic representation of a second embodiment of a method according to the invention, in the form of a block diagram,

FIG. 4: A schematic representation of a first embodiment of a vehicle according to the invention, and

FIG. 5: A schematic representation of a second embodiment of a vehicle according to the invention.

### DESCRIPTION OF PREFERRED EXAMPLE EMBODIMENTS

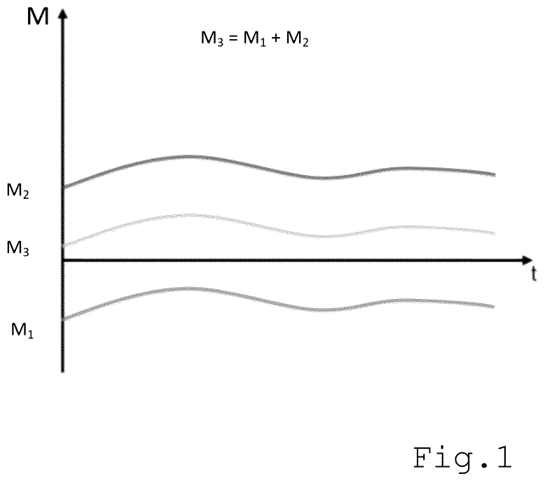

FIG. 1 shows a schematic representation of a method according to the invention. Specifically, FIG. 1 shows a method according to the invention in the form of a torque diagram. In the torque diagram a first torque M₁, a second torque M₂, and a driving torque M₃ are plotted against time t. The first torque M₁ is in the negative range of the Y-axis, and is therefore a generator torque. The second torque M₂ is in the positive range of the Y-axis and is therefore a motor torque. The driving torque M₃ is the sum of the first torque M₁ and the second torque M₂. To produce the second torque M₂ in a vehicle, a certain direct current is drawn from a battery (not shown in FIG. 1), this direct current is converted by an inverter system (also not shown in FIG. 1) into an alternating current and that alternating current is used in order to operate a second electric drive unit (also not shown in FIG. 1) as a motor and thereby to produce the second torque M₂ as a motor torque. At the same time, a first electric drive unit (also not shown in FIG. 1) is used, so to speak, to brake the vehicle in that it is operated as a generator and so produces the first torque M₁ as a generator torque. During this operation, a direct current is produced, which flows through the inverter system (again not shown in FIG. 1) in order to either be fed back into a battery or to be fed into the inverter system again as a direct current. Accordingly, the total current flowing through the inverter system is therefore larger than a total current that would be necessary to produce the driving torque M₃ only by means of the motor operating mode. Due to the fact that a larger total current is flowing in the system, specifically in the inverter system, than in a case where both torques are motor torques, the components of the vehicle in which the method is being applied heat up more quickly, among other things because by virtue of the larger total current higher heat losses also occur in the individual components.

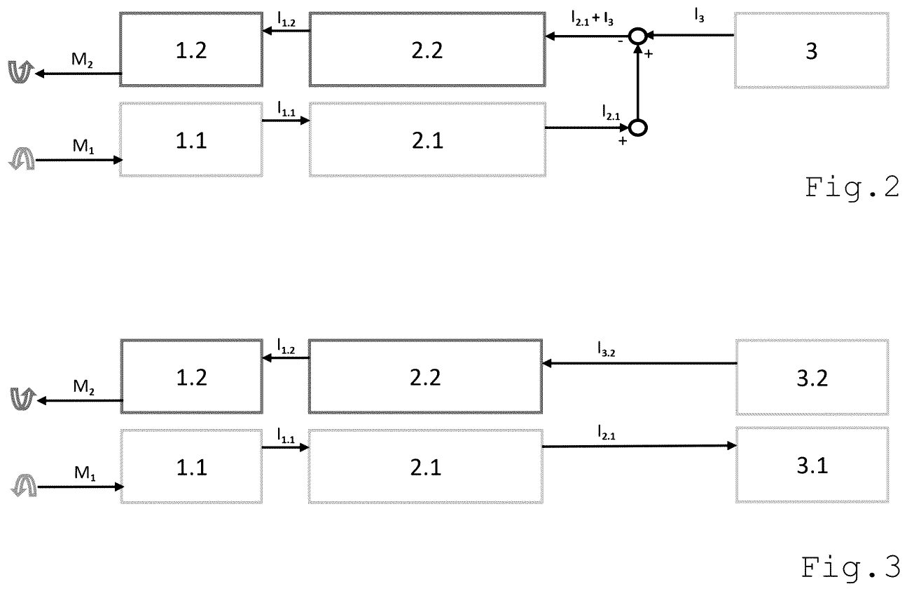

FIG. 2 now shows a schematic representation of a first embodiment of a method according to the invention, in the form of a block diagram. In particular FIG. 2 shows a first electric drive unit 1.1, which produces a first torque M₁, and which is a generator torque. Furthermore FIG. 2 shows a second electric drive unit 1.2, which produces a second torque M₂, which is a motor torque. Thus, in combination the two electric drive units 1.1 and 1.2 produce a driving torque which is calculated as the sum of the motor, second torque M₂ and the generator, first torque M₁. Furthermore, in FIG. 2 a first inverter 2.1 and a second inverter 2.2 are shown, which are both part of an inverter system. The first inverter 2.1 receives an alternating current I_{1.1} produced by the first electric drive unit 1.1 operating as a generator. The second inverter 2.2 delivers an alternating current I_{1.2} which it produces itself, which is received by the second electric drive unit 1.2 in order to produce the second torque M₂ as a motor. From the alternating current I_{1.1} it receives, the first inverter 2.1 produces a direct-current output I_{2.1}. That direct-current output I_{2.1} is then fed to the second inverter 2.2. In addition, in the method illustrated in FIG. 2 a battery direct-current input I₃ is also supplied to the second inverter 2.2. Thus, in total a sum of the direct-current output I_{2.1} from the first inverter and the battery direct-current input I₃ is fed into the second inverter 2.2. Accordingly, it can be seen in the first place in FIG. 2 that overall, a larger total current flows through the inverter system with the first inverter 2.1 and the second inverter 2.2 than in a case where the two electric drive units are both operated as motors in order to produce the desired driving torque. In the second place it can be seen that the direct-current output I_{2.1} produced by the first inverter 2.1 is fed back directly into the second inverter, in particular without being diverted through a battery. Consequently, in relation to this direct-current output I_{2.1} charging and discharging losses are avoided.

FIG. 3 shows a schematic representation of a second embodiment of a method in the form of a block diagram, according to the invention. FIG. 3 again shows an inverter system with a first inverter 2.1 and a second inverter 2.2. In addition, again a first electric drive unit 1.1 and a second electric drive unit 1.2 are shown. Again, the first electric drive unit 1.1, operating as a generator, produces a first torque M₁ and the second electric drive unit 1.2, operating as a motor, produces a second torque M₂. Correspondingly, the second inverter 2.2 of the second electric drive unit 1.2 again produces an alternating current I_{1.2}. Furthermore, the first electric drive unit 1.1 again feeds the generator alternating current I_{1.1} that it produces into the first inverter 2.1. The second inverter 2.2 draws a direct current I_{3.2} from the battery 3.2 as a battery input direct current. Accordingly, in the example embodiment illustrated in FIG. 3 the battery 3.2 is in fact being discharged. In contrast, the first inverter 2.1 supplies a direct current output I_{2.1} to the battery 3.1 in order to charge that battery 3.1. Thus, in the example shown in FIG. 3 it can be supposed that the battery charge of the battery 3.2 is greater than a battery charge of the battery 3.1, and for that reason the method is carried out in such manner that the battery 3.1 is charged and the battery 3.2 is discharged. When now the charge conditions of the two batteries 3.1 and 3.2 are equal and in particular the charging of the battery 3.1 is more than that of the battery 3.2, then the method can be adapted in such manner that the second electric drive unit 1.2 changes to generator operation and so charges the battery 3.2 whereas the electric drive unit 1.1 changes to electric motor operation and so discharges the battery 3.1. In that way the charge conditions of the two batteries are also equalized.

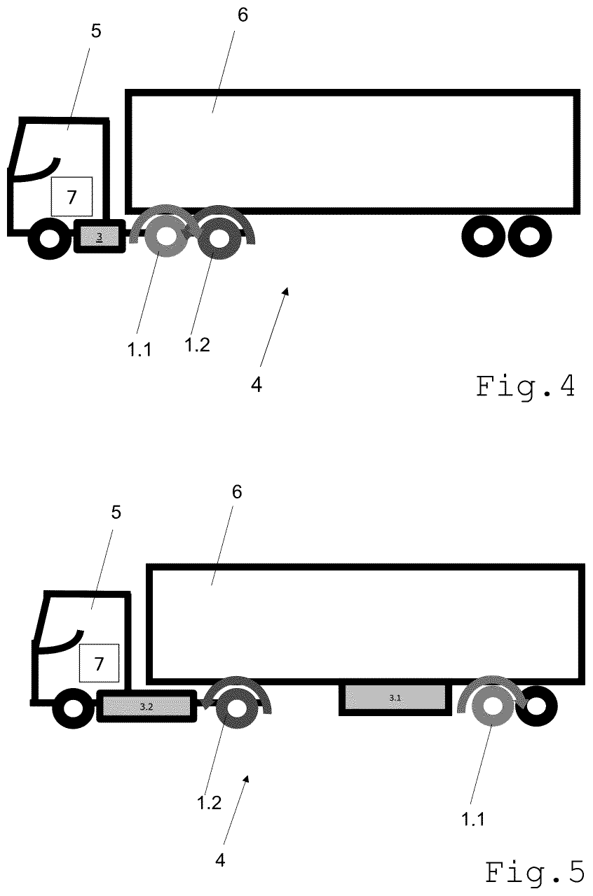

FIG. 4 now shows a schematic representation of a first embodiment of a vehicle 4 according to the invention. The vehicle 4 comprises a tractor machine 5 and a trailer 6. In addition, the vehicle 4 comprises a first electric drive unit 1.1 and a second electric drive unit 1.2. The first electric drive unit 1.1 is operated as a generator (and it can therefore be said that it brakes the vehicle 4). The second electric drive unit 1.2 is operated as a motor (and it can be said that it drives the vehicle 4). Typically, the electric drive units 1.1, 1.2 can comprise one or more electric motors which, however, are not explicitly shown in FIG. 4. The electric drive units in FIG. 4 are also represented in such manner that each comprises a respective axle of the tractor machine 5. Furthermore, the vehicle 4 and in particular the tractor machine 5 comprises a battery 3. Moreover the vehicle 4 and specifically the tractor machine 5 comprises a system 7 according to the invention, which is designed to be able to carry out the method described with reference to FIG. 2.

FIG. 5 now shows a schematic representation of a second embodiment of a vehicle 4 according to the invention. The vehicle 4 again comprises a tractor machine 5, a trailer 6 and a system 7 according to the invention. In addition, the vehicle shown in FIG. 5 comprises a first electric drive unit 1.1 which is operated as a generator and a second electric drive unit which is operated as a motor. The trailer has a battery 3.1 and the tractor machine has a battery 3.2. Since the first electric drive unit 1.1 is being operated as a generator a direct current is fed into the battery 3.1, so that the battery 3.1 is being charged as described with reference to FIG. 3. Analogously, the motor operation of the second drive unit 1.2 draws a direct current from the battery 3.2, as described with reference to FIG. 3, so that the battery 3.2 is being discharged. The system 7 is able to carry out a method as described with reference to FIG. 3, and in particular to coordinate the charging and discharging of the batteries 3.1 and 3.2.

The invention is not limited to the example embodiments shown. Rather, its protective scope is defined by the claims.

### INDEXES

1.1 First electric drive unit
1.2 Second electric drive unit
2.1 First inverter
2.2 Second inverter
3, 3.1, 3.2 Batteries
4 Vehicle
5 Tractor machine
6 Trailer
7 System
I_{1.1} Alternating current produced by the first electric drive unit operating as a generator
I_{1.2} Alternating current fed into the second electric drive unit
I_{2.1} Direct-current output produced by the first inverter
I₃, I_{3.2} Battery direct current input produced by the second inverter
M₁ First torque
M₂ Second torque
M₃ Driving torque

1-11. (canceled)

12. A method for heating components of a vehicle (4) having a first electric drive unit (1.1), a second electric drive unit (1.2), and an inverter system, the method comprising:
producing a first torque (M₁) by the first electric drive unit (1.1);
producing a second torque (M₂) by-the second electric drive unit (1.2);
summing the first torque (M₁) and the second torque (M₂) to provide a driving torque (M₃);
supplying, by the inverter system (2.1, 2.2), the first and second electric drive units (1.1, 1.2) with alternating current (I_{1.2}), and
operating the first electric drive unit (1.1) as a generator and operating the second electric drive unit (1.2) as a motor, for producing a desired driving torque (M₃), in such manner that a total current flow produced in the inverter system (2.1, 2.2) is larger than a total current flow that would be produced in the inverter system (2.1, 2.2) when both of the first and second electric drive units (1.1, 1.2) are operated as motors to obtain the desired driving torque (M₃).

13. The method according to claim 12, wherein the inverter system (2.1, 2.2) comprises a first inverter (2.1) for supplying the first electric drive unit (1.1) with alternating current and a second inverter (2.2) for supplying the second electric drive unit (1.2) with alternating current, wherein the first inverter (2.1) produces a first direct-current output (I_{2.1}) and supplies the first direct-current output (I_{2.1}) to the second inverter (2.2) as an inverter direct-current input.

14. The method according to claim 13, further comprising:
supplying a battery direct-current input (I₃) into the second inverter (2.2).

15. The method according to claim 12, wherein:
the vehicle contains a first battery (3.1) and a second battery (3.2);
the inverter system comprises a first inverter (2.1) electrically connected exclusively to and associated with the first battery (3.1), and a second inverter (2.2) is electrically connected exclusively to and associated with the second battery (3.2);
the first inverter (2.1) is electrically connected exclusively to and associated with the first electric drive unit (1.1);
the second inverter (2.2) is electrically connected exclusively to and associated with the second electric drive unit (1.2);
one of the first or second electric drive unit is operated as a generator and feeds a direct current (I_{2.1}) into the respective first battery (3.1) or second battery (3.2); and
the other of the first or second electric drive unit is operated as a motor and receives a direct current (I_{3.2}) from the respective other first or second battery (3.2).

16. The method according to claim 15, comprising:
determining which of the first or second batteries (3.1, 3.2) into which current is to be fed and from which current is to be drawn based on respective charge conditions and/or temperatures of the first and second batteries (3.1, 3.2).

17. The method according to claim 16, wherein determining is performed continuously.

18. The method according to claim 12, wherein each of the first and second electric drive units (1.1, 1.2) comprises a plurality of electric motors, each of the plurality of electric motors of both the first and second drive units (1.1, 1.2) are all operated as motors or all operated as generators.

19. The method according to claim 12, wherein each of the first and second electric drive units (1.1, 1.2) comprises a plurality of electric motors, and wherein some of the plurality of electric motors are operated as motors and some of the plurality of electric drive motors are operated as generators.

20. The method according to claim 12, wherein the inverter system (2.1, 2.2) comprises more than two inverters (2.1, 2.2), and the method comprises:
feeding a direct current from at least one battery (3, 3.1, 3.2) and/or feeding a direct current from at least one of the more than two inverters (2.1, 2.2) into at least one other of the more than two inverters (2.1, 2.2); and
feeding, from at least one of the more than two inverters (2.1, 2.2), a direct current into at least one battery (3, 3.1, 3.2) and/or into at least one other of the more than two inverters (2.1, 2.2).

21. A system (7) comprising means for carrying out, at least in part, a method according to claim 12.

22. A vehicle configured to carry out the method according to claim 12.

23. A computer-readable medium containing computer code which, when executed by a computer, performs the method according to claim 12.
